(19) United States
(12) Patent Application Publication
(10) Pub. No.: US 2014/0373067 A1
(43) Pub. Date: Dec. 18, 2014

(54) Electronic Device, Method, and Computer Program Product

(71) Applicants: Kabushiki Kaisha Toshiba, Tokyo (JP); Toshiba Lifestyle Products & Services Corporation, Tokyo (JP)

(72) Inventors: Munehiro Tokikura, Kawasaki Kanagawa (JP); Yosuke Takahashi, Kokubunji (JP); Kentaro Nagahama, Tachikawa (JP); Naoki Esaka, Tachikawa (JP)

(21) Appl. No.: 14/472,068

(22) Filed: Aug. 28, 2014

Related U.S. Application Data
(63) Continuation of application No. PCT/JP2013/058751, filed on Mar. 26, 2013.

(51) Int. Cl. H04N 21/458; H04N 21/482; H04N 21/462; H04N 21/239; H04N 21/262

(52) U.S. Cl. CPC H04N 21/4586; H04N 21/2393; H04N 21/26291; H04N 21/462; H04N 21/4583; H04N 21/482; H04N 21/26283
USPC 725/50

(57) ABSTRACT

According to one embodiment, an electronic device includes a processing circuitry to make a request to a server so as to acquire a channel list via a communication network, to compare a first channel list acquired newly with a second channel list acquired previously, and, if the second channel list is to be updated with the first channel list, to acquire first program information corresponding to the first channel list from the server, and to generate a program guide by using the first channel list and the first program information.

### CROSS-REFERENCE TO RELATED APPLICATIONS

This application is a continuation of international application No. PCT/JP2013/058751, filed Mar. 26, 2013, which designates the United States, the entire contents of which are incorporated herein by reference.

### FIELD

Embodiments described herein relate generally to an electronic device, a method, and a computer program product.

### BACKGROUND

Conventionally, there is known a program information display device (program information management device) that presents to a user a program information screen in a program guide format by acquiring a channel list and program information from a metadata server storing a channel list including channel codes and program information (including program related information) about each channel.

Consequently, by performing operation with respect to a program information screen on the program information display device, the user can view desired program information and related information, and can make reservation on recordings and the like.

When the channels (channel information) included in the channel list stored in the metadata server are added, changed, or deleted and the metadata server is configured to notify the program information display device of such an addition, change, or deletion, cost for operating the metadata server is generated.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic configuration block diagram illustrating a program information distribution system according to one embodiment;

FIG. 2 is an exemplary functional configuration block diagram illustrating a program information display device which functions as a program information management device, according to one embodiment;

FIG. 3 is an exemplary processing flowchart illustrating initial setting processing, according to one embodiment;

FIG. 4 is an exemplary explanatory diagram illustrating an example of a service provider selection screen, according to one embodiment;

FIG. 5 is an exemplary explanatory diagram illustrating an example of a program guide displayed, according to one embodiment;

FIG. 6 is an exemplary processing flowchart illustrating program guide display processing according to a first embodiment;

FIG. 7 is a processing flowchart illustrating program guide display processing according to a modification of the first embodiment;

FIG. 8 is an exemplary processing flowchart illustrating program guide display processing according to a second embodiment;

FIG. 9 is an exemplary explanatory diagram illustrating problems in a case where a start time of a program in an electronic program guide (EPG) included in a broadcast wave is slightly earlier than a start time of a program in a program guide that can be presented to a user, in the embodiment;

FIG. 10 is an exemplary explanatory diagram illustrating problems in a case where a start time of a program in an electronic program guide (EPG) included in a broadcast wave is slightly later than a start time of a program in a program guide that can be presented to a user, in the embodiment; and

FIG. 11 is an exemplary explanatory diagram illustrating a third embodiment.

### DETAILED DESCRIPTION

In general, according to one embodiment, a program information management device comprises a processing circuitry to make a request to a server so as to acquire a channel list via a communication network, to compare a first channel list acquired newly with a second channel list acquired previously, and, if the second channel list is to be updated with the first channel list, to acquire first program information corresponding to the first channel list from the server, and to generate a program guide by using the first channel list and the first program information.

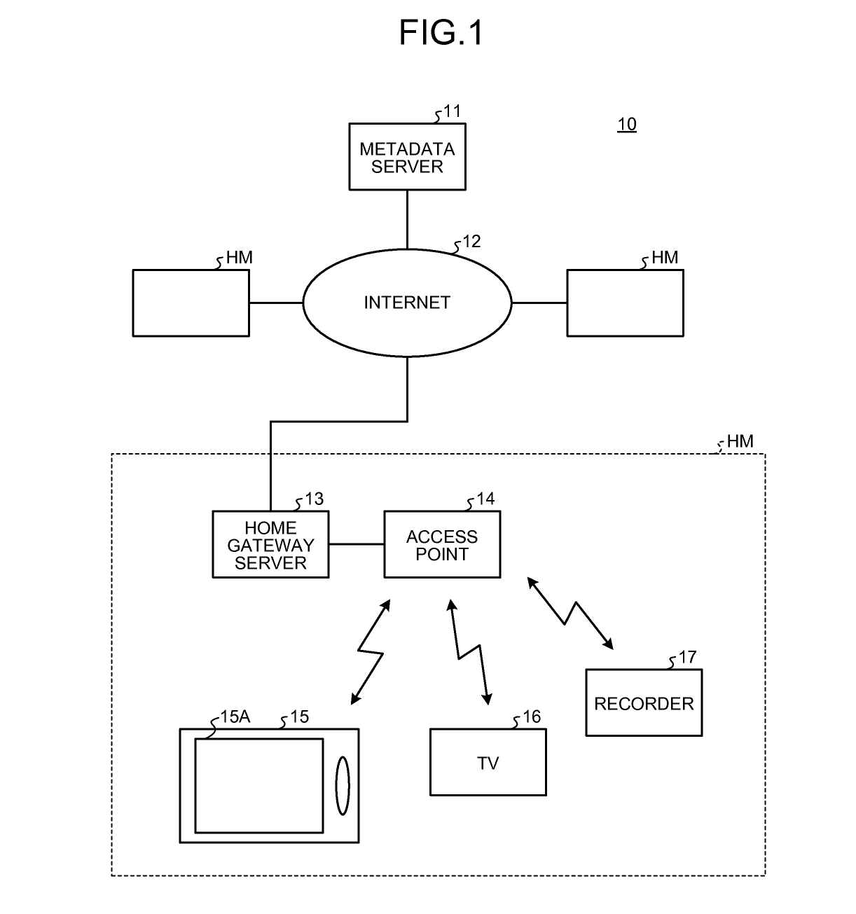

FIG. 1 is a schematic configuration block diagram of a program information distribution system according to an embodiment.

A program information distribution system 10 includes: a metadata server 11 that distributes program information; a home gateway server 13 arranged in each home HM and connected via the Internet 12 to the metadata server 11; an access point 14 capable of connecting to the home gateway server 13; a program information display device (program information management device) 15 configured as a tablet (portable information processor) having a touch panel display 15A that can connect to the metadata server 11 via the access point 14, the home gateway server 13, and the Internet 12; a television 16; and a recorder 17.

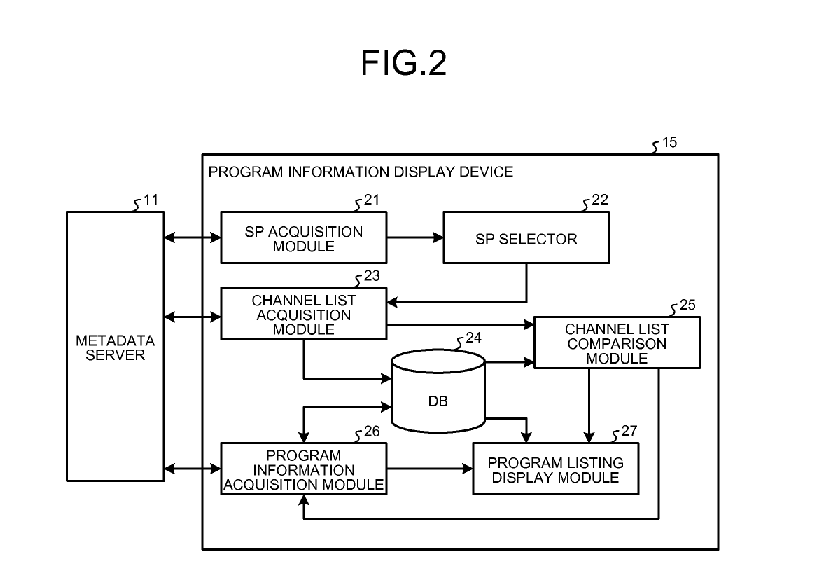

FIG. 2 is a functional configuration block diagram illustrating the program information display device which functions as the program information management device.

The program information display device 15 includes a service provider (SP) acquisition module 21, a service provider (SP) selector 22, a channel list acquisition module 23, and a database (DB) 24. The SP acquisition module 21 acquires information about a service provider (for example, a digital terrestrial broadcast station, a broadcast satellite digital broadcast station, a communication satellite digital broadcast station) from the metadata server 11. The SP selector 22 is a selector with which the user performs selection operation to select a service provider which is to display a program guide based on the information acquisition result of the service provider acquisition module 21. The channel list acquisition module 23 acquires a channel list from the metadata server 11 via the Internet 12. The DB 24 stores therein the acquired channel list and the corresponding program information.

In this case, the program information display device 15 is configured as a so-called portable computer. The program information display device 15 includes: an MPU that controls the entire program information display device 15; a ROM that stores various kinds of control programs including the operating system in a non-volatile manner; a RAM used as a working area to temporarily store various kinds of data; an external storage device configured as a hard disk device, a solid state drive (SSD), and the like; the touch panel display 15A; a wireless communication interface capable of structuring a wireless LAN; and a USB interface capable of connecting a USB memory and the like.

The program information display device 15 includes a channel list comparison module 25, a program information acquisition module 26, and a program guide display 27. The channel list comparison module 25 compares the channel list newly acquired by the channel list acquisition module 23 and the channel list already stored in the database 24. The program information acquisition module 26 acquires program information (for example, a program title, a broadcast time zone, a channel logo, a broadcast station name, and the like) corresponding to the channel list newly acquired by the channel list acquisition module 23 via the Internet 12 from the metadata server 11 in a case where the channel list newly acquired by the channel list acquisition module 23 is determined not to match the channel list already stored in the database 24 (this includes a case where the channel list is not stored in the database 24) based on the comparison result of the channel list comparison module 25. The program guide display 27 displays a program guide based on the latest channel list based on the comparison result of the channel list comparison module 25 and the program information corresponding to the latest channel list and acquired by the program information acquisition module 26.

Next, operation of the program information display device according to the embodiment will be explained.

First, the initial setting processing of the program guide display performed by the program information display device 15 will be explained.

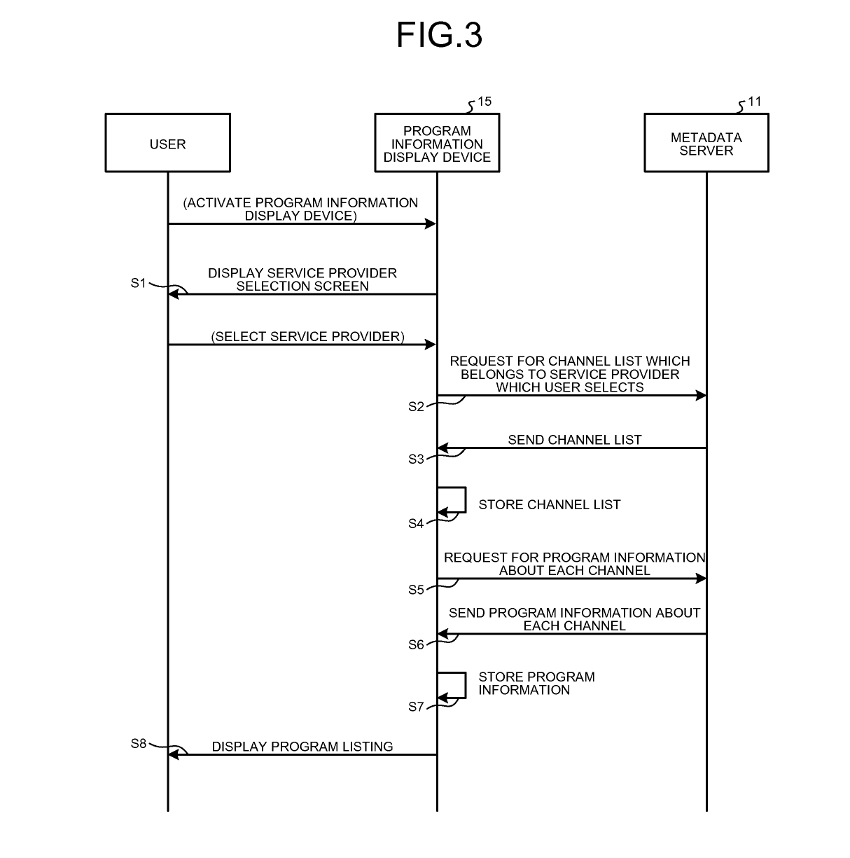

FIG. 3 is a processing flowchart illustrating the initial setting processing.

First, when the user activates the program information display device, the program information display device 15 displays a service provider selection screen based on information about the service provider which is acquired by the service provider acquisition module 21 in advance and which can be used by the user (S1).

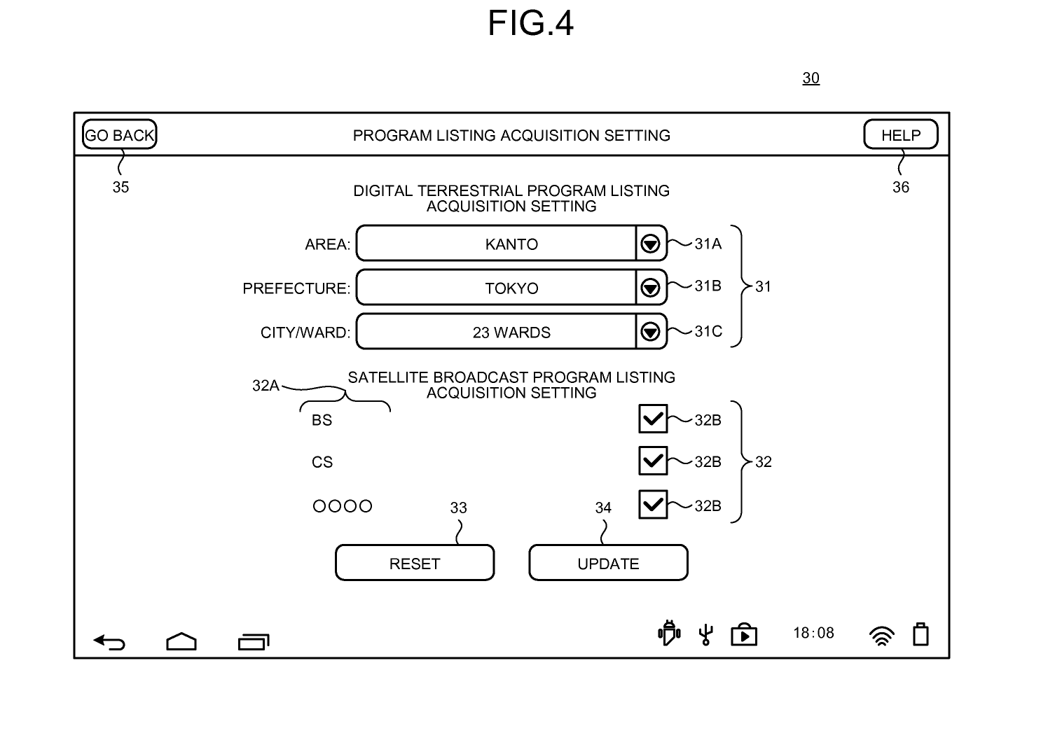

FIG. 4 is an explanatory diagram illustrating an example of service provider selection screen.

The service provider selection screen (program guide acquisition setting screen) 30 includes: a digital terrestrial broadcast program guide acquisition setting area 31; a satellite broadcast program guide acquisition setting area 32; a reset button 33 that resets the setting content to the initial state; an update button 34 that updates so as to reflect the setting content; a go-back button 35 for terminating display of the service provider selection screen (program guide acquisition setting screen) 30; and a help button 36 that displays various kinds of explanations on the service provider selection screen (program guide acquisition setting screen) 30.

The digital terrestrial broadcast program guide acquisition setting area 31 of the service provider selection screen (program guide acquisition setting screen) 30 includes: an area setting area 31A that sets an area where the digital terrestrial broadcast is received (“Kanto region” in the example of FIG. 4); a prefecture name setting area 31B that sets the prefecture name in the area where the digital terrestrial broadcast is received; and a municipal district setting area 31C that sets the names of cities, wards, towns, and villages in the prefecture where the digital terrestrial broadcast is received.

The satellite broadcast program guide acquisition setting area 32 of the service provider selection screen (program guide acquisition setting screen) 30 includes: a satellite broadcast type display area 32A that displays the type of the satellite broadcast of the reception target (“BS”, “CS”, “XXXX”, . . . in the example of FIG. 4); and an acquisition target display selection area 32B corresponding to each type of the satellite broadcast and displaying a check mark when it is a satellite broadcast program guide acquisition target.

Therefore, in the service provider selection screen (program guide acquisition setting screen) 30, the user selects an area, a prefecture, a city, award, a towns, and a village where the user wants to acquire the digital terrestrial broadcast program guide in order to receive the digital terrestrial broadcast. Further, in the service provider selection screen 30, the user selects the type of the satellite broadcast with which the user wants to acquire the satellite broadcast program guide in order to receive the satellite broadcast.

Subsequently, when the user operates an operation unit of the program information display device 15 which functions as the service provider selector 22 and the user select a service provider, the program information display device 15 functions as the channel list acquisition module (request module) 23. Then, the program information display device 15 makes a request to the metadata server 11 via the Internet 12 to send a channel list which belongs to the service provider which the user selects (S2).

In response to the request of the channel list in S2, the metadata server 11 sends the corresponding channel list via the Internet 12 to the program information display device 15 (S3).

Therefore, the program information display device 15 which functions as the channel list acquisition module 23 stores the acquired channel list to the database 24. Then, the program information display device 15 functions as the channel list comparison module (comparison module) 25, and tries to compare the newly acquired channel list with the channel list acquired previously and already stored in the database 24. However, in this case, the channel list stored previously does not exist in the database 24.

Therefore, the program information display device 15 functions as the program information acquisition module (acquisition module) 26. Then, the program information display device 15 makes a request to the metadata server 11 via the Internet 12 to send the program information about each channel based on the channel list acquired by the channel list acquisition module 23 this time and stored in the database 24 (S5).

Therefore, the metadata server 11 sends the program information display device 15 the program information about each channel corresponding to the channel list which the program information display device 15 stored in the database 24 (S6).

Subsequently, the program information display device 15 which functions as the program information acquisition module 26 stores the acquired program information in the database 24 (S7).

As a result, the program information display device 15 which functions as the program guide display 27 displays the program guide based on the latest channel list stored in the database 24 and the corresponding program information (S8).

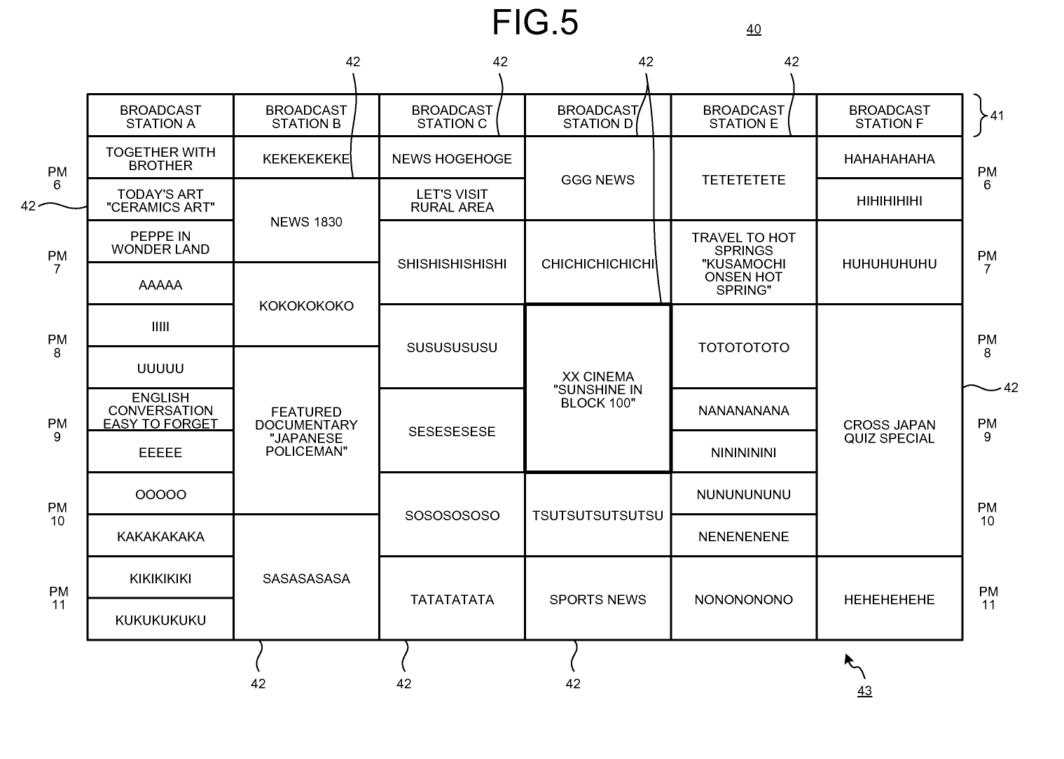

FIG. 5 is an explanatory diagram illustrating an example of program guide displayed.

The program guide 40 includes a broadcast station name display field 41 that displays broadcast station names and a program display field 43 that displays program information (program names in the example of FIG. 5) for each time zone in such a manner that each program information is divided into a corresponding program frame 42.

More specifically, in FIG. 4, a program name [XX cinema “sunshine in block 100”] of a program which is broadcast from 7:30 p.m. to 9:30 p.m. is displayed in a program frame 42 indicated by a thick black frame.

Subsequently, the program guide display processing performed by the program information display device 15 after the initial setting is finished will be explained.

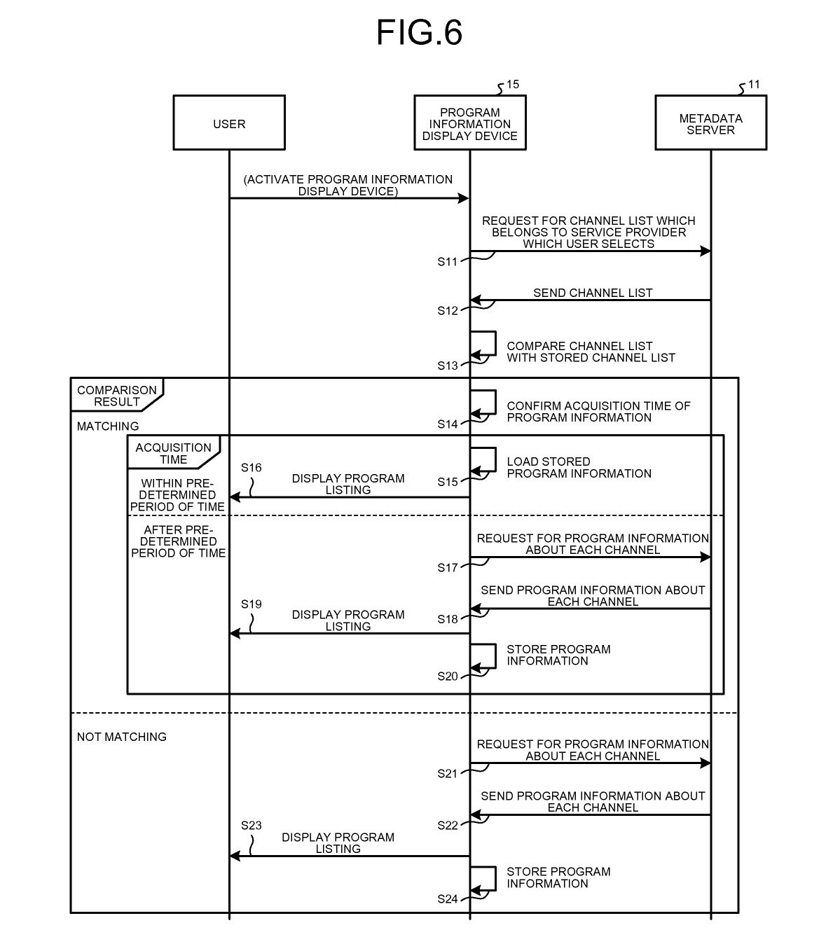

FIG. 6 is a processing flowchart illustrating program guide display processing according to the first embodiment.

First, when the user activates the program information display device, the program information display device 15 functions as the channel list acquisition module (request module) 23. Then, the program information display device 15 makes a request to the metadata server 11 via the Internet 12 to send the channel list which belongs to the service provider selected by the user in the initial setting processing (S11).

In reply to the request for the channel list in S11, the metadata server 11 sends the corresponding channel list via the Internet 12 to the program information display device 15 (S12).

Subsequently, the program information display device 15 functions as the channel list comparison module 25, and compares the channel list stored in the database 24 (corresponding to a second channel list) and the channel list sent in S12 (corresponding to a first channel list) (S13).

When, in the comparison of S13, the channel list stored in the database 24 matches the channel list sent in S12 (S13: matched), the acquisition time of the program information is confirmed (S14).

When, in the confirmation of S14, the elapsed time from the acquisition time of the previous program information to the acquisition time of the program information is within a certain period of time (for example, 24 hours) (S14: within certain period of time), the program information display device 15 loads the program information stored in the database 24 (S15). Then, the program information display device 15 generates the program guide, and displays the program guide on the touch panel display. Then, the processing ends (S16).

If, in the confirmation of S14, the elapsed time from the acquisition time of the previous program information to the acquisition time of the program information is more than the certain period of time (for example, 24 hours) (S14: more than certain period of time), there is a possibility that the content of the channel list, i.e., the program information, has been updated even though the channel lists match each other. Therefore, the program information display device 15 functions as the program information acquisition module 26. Then, the program information display device 15 makes a request to the metadata server 11 via the Internet 12 to send the program information about each channel based on the channel list which is acquired by the channel list acquisition module 23 this time and stored in the database 24 (S17).

Therefore, the metadata server 11 sends the program information display device 15 the program information about each channel corresponding to the channel list stored by the program information display device 15 to the database 24 (S18).

The program information display device 15 generates the program guide based on the received program information, and displays the program guide on the touch panel display (S19).

Subsequently, the program information display device 15 stores the program information sent in S18 in the database 24, and terminates the processing (S20).

When, in the comparison in S13, the channel list saved in the database 24 does not match the channel list sent in step S12 (S13: not matching), the program information display device 15 functions as the program information acquisition module 26. Then, the program information display device 15 makes a request to the metadata server 11 via the Internet 12 to send the program information about each channel based on the newly received channel list (S21).

Therefore, the metadata server 11 sends to the program information display device 15 the program information about each channel corresponding to the channel list which is newly stored by the program information display device 15 to the database 24 (S22).

The program information display device 15 generates the program guide based on the received program information, and displays the program guide on the touch panel display (S23).

Subsequently, the program information display device 15 saves the program information received in S22 to the database 24, and terminates the processing (S24).

According to the present embodiment according to the above explanation, the program guide can be presented to the user based on the latest channel list.

As a result, according to this first embodiment, mismatch with the electronic program guide (Electronic Program guide: EPG) included in the broadcast wave is suppressed in the program guide that can be presented to the user, and the control of the recording reservation and the like can be done more reliably using the program information display device 15.

### Modification of First Embodiment

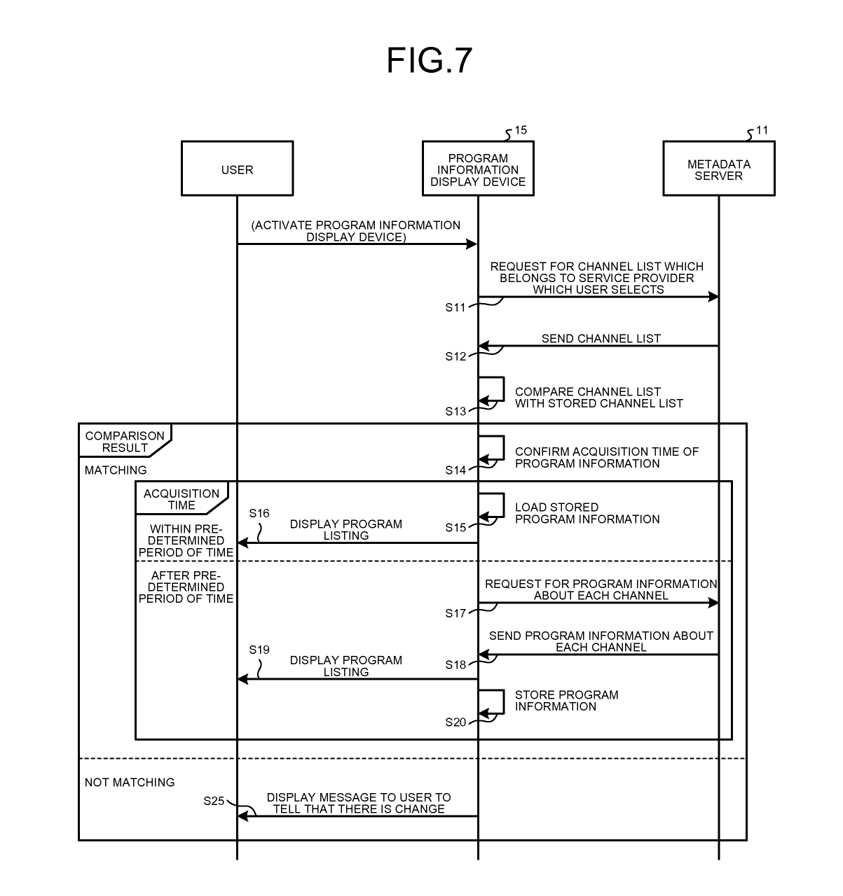

FIG. 7 is a processing flowchart illustrating program guide display processing according to a modification of the first embodiment.

In FIG. 7, the same units as those of the first embodiment in FIG. 6 are denoted with the same reference numerals. In the explanation about the above first embodiment, when the channel list sent from the metadata server 11 does not match the channel list already saved in the database 24, the program information about each channel is automatically requested based on the newly received channel list, and the program information is sent by the metadata server 11.

The same processing as those in S11 to S20 in FIG. 6 is performed in this modification of the first embodiment.

By the way, the acquisition of the program information imposes heavy burden on the program information display device 15. Therefore, in this modification, the newly received channel list and the channel list already stored in the database 24 are stored, and when the newly received channel list does not match the channel list already saved in the database 24, a message is displayed to inform the user that the channel list is changed (S25).

As a result, according to this modification of the first embodiment, the user determines whether it is necessary to update the program information or not, and only when it is necessary to update the program information, the program information can be updated, and the operability of the program information display device 15 by the user is improved.

### Second Embodiment

Subsequently, the second embodiment will be explained.

In this second embodiment, the system configuration is the same, and therefore, the explanation in FIG. 1 is incorporated herein by reference.

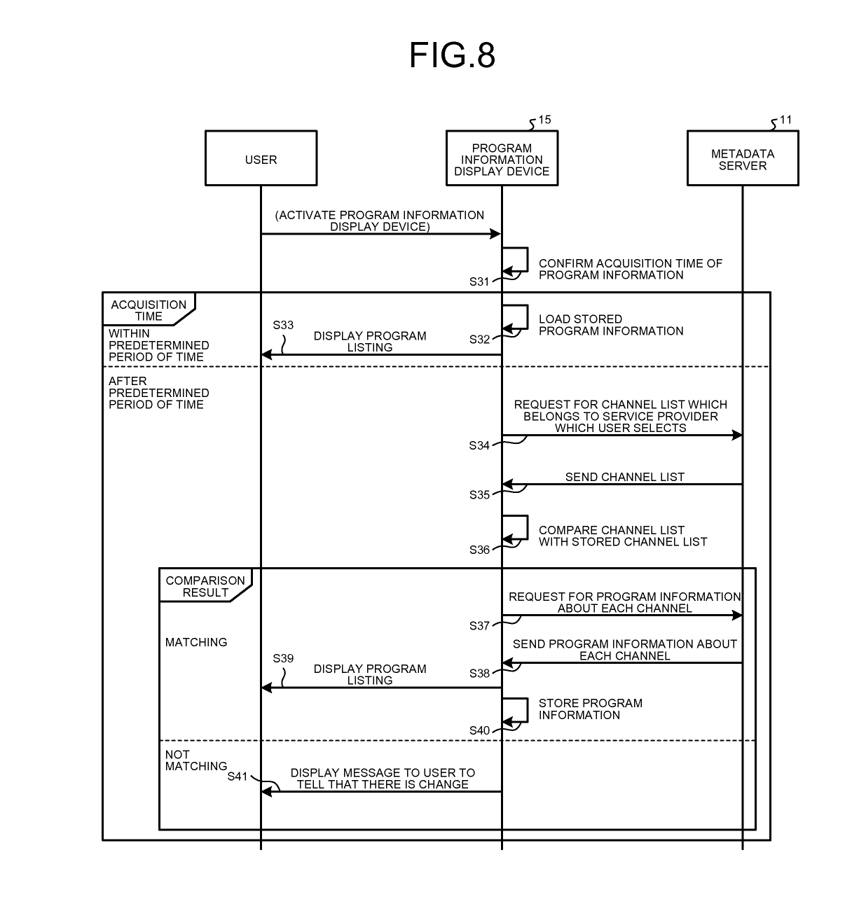

FIG. 8 is a processing flowchart illustrating program guide display processing according to the second embodiment.

First, the program information display device 15 confirms the acquisition time of the program information (S31).

When, in the confirmation of S31, the elapsed time from the acquisition time of the previous program information to the acquisition time of the program information is within a certain period of time (for example, 24 hours) (S31: within the certain period of time), the program information display device 15 loads the program information stored in the database 24 (S32). Then, the program information display device 15 generates the program guide, and displays the program guide on the touch panel display. Thereafter, the processing ends (S33).

When, in the confirmation of S31, the elapsed time from the acquisition time of the previous program information to the acquisition time of the program information is more than the certain period of time (for example, 24 hours) (S31: more than the certain period of time), the program information display device 15 functions as the channel list acquisition module 23. Then, the program information display device 15 makes a request to the metadata server 11 via the Internet 12 to send the channel list which belongs to the service provider selected in the initial setting processing by the user (S34).

In response to the request of the channel list in S34, the metadata server 11 sends the corresponding channel list via the Internet 12 to the program information display device 15 (S35).

Subsequently, the program information display device 15 functions as the channel list comparison module 25, and compares the channel list stored in the database 24 (corresponding to the second channel list) and the channel list sent in S12 (corresponding to the first channel list) (S36).

If, in the comparison of S36, the channel list stored in the database 24 matches the channel list sent in S35 (S36: matching), there is a possibility that the content, i.e., the program information, has been updated even though the channel lists match each other. Therefore, the program information display device 15 functions as the program information acquisition module 26. Then, the program information display device 15 makes a request to the metadata server 11 via the Internet 12 to send the program information about each channel based on the channel list which is acquired by the channel list acquisition module 23 this time and stored in the database 24 (S37).

Therefore, the metadata server 11 sends to the program information display device 15 the program information about each channel corresponding to the channel list stored by the program information display device 15 to the database 24 (S38).

The program information display device 15 generates the program guide on the basis of the received program information, and displays the program guide on the touch panel display (step S39).

Subsequently, the program information display device 15 saves the program information sent in S38 to the database 24, and terminates the processing (S40).

When, in the comparison in S36, the channel list stored in the database 24 does not match the channel list sent in S35 (S36: not matching), a message is displayed to inform the user that the channel list is changed (S41). As a result, the user is prompted to determine whether to request the program information and update the display of the program guide.

As explained above, according to this second embodiment, as long as the acquisition time of the program information is within the certain period of time, processing is performed while the content of the channel list is considered not to be changed, and therefore, the processing load can be reduced, and the processing time can be reduced.

### Third Embodiment

In the above explanation, mismatch with the electronic program guide (EPG) included in the broadcast wave is suppressed in the program guide that can be presented to the user, and the control of the recording reservation and the like can be done more reliably using the program information display device 15, but the measures for solving the case where the mismatch may occur has not been explained.

This third embodiment is an embodiment for solving the case where there is mismatch between the program guide that can be presented to the user and the electronic program guide (EPG) included in the broadcast wave.

First, a case where a start time of a program in an electronic program guide (EPG) included in a broadcast wave is slightly earlier than a start time of a program in a program guide that the program information display device 15 can present to a user will be explained.

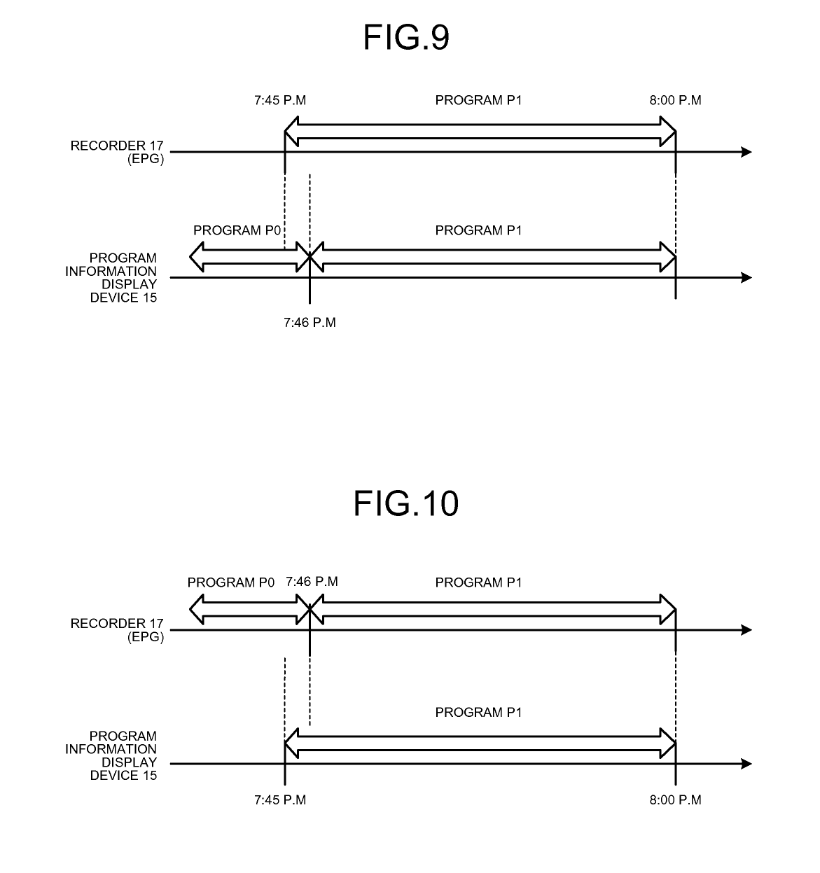

FIG. 9 is an explanatory diagram illustrating the problem associated with the case where the start time of the program in the electronic program guide (EPG) included in the broadcast wave is slightly earlier than the start time of the program in the program guide that can be presented to the user.

As illustrated in FIG. 9, for example, the following case will be explained: the start time of the program in the program guide that the program information display device 15 can present to the user is 7:46 p.m. whereas the start time of the program in the electronic program guide (EPG) included in the broadcast wave is 7:45 p.m.

In this case, a basic idea for designating a program in a case where the program information display device 15 performs recording reservation will be explained.

When the program information display device 15 performs the recording reservation with the recorder 17, the broadcast start time of the program designated by the user with the program information display device 15 is acquired, and the recorder 17 is commanded to perform the recording reservation of the program which is broadcast at the broadcast start time.

As a result, the recorder 17 performs the recording reservation to record the program which is considered to be broadcast at the commanded broadcast start time.

As a result, as illustrated in FIG. 9, where the start time (=7:45 p.m.) of the program in the electronic program guide (EPG) included in the broadcast wave is slightly earlier than the start time (=7:46 p.m.) of the program in the program guide that can be presented to the user, the recorder 17 is programmed to record the program P1 which is broadcast at the start time (=7:46 p.m.) of the program in the program guide that can be presented to the user, and therefore there would be virtually no problem.

However, when the reservation is confirmed with the program information display device 15, the recorder 17 sends the program information display device 15 the start time and the end time of the program P1 in the electronic program guide (EPG) included in the broadcast wave.

As a result, the start time of the program P1 is a time zone of a program P0 in the program guide of the program information display device 15, and therefore, the program P0 appears to be programmed for recording reservation.

Therefore, the user recognizes that the program P0, which is different from the program P1 which the user wanted to program for recording reservation, is programmed for recording reservation, and this cause problem.

Subsequently, a case where a start time of a program in an electronic program guide (EPG) included in a broadcast wave is slightly later than a start time of a program in a program guide that the program information display device 15 can present to the user will be explained.

FIG. 10 is an explanatory diagram illustrating the problem associated with the case where the start time of the program in the electronic program guide (EPG) included in the broadcast wave is slightly later than the start time of the program in the program guide that can be presented to the user.

As illustrated in FIG. 10, for example, the following case will be explained: the start time of the program in the program guide that the program information display device 15 can present to the user is 7:45 p.m. whereas the start time of the program in the electronic program guide (EPG) included in the broadcast wave is 7:46 p.m.

As described above, the recorder 17 performs the recording reservation to record the program which will be broadcast at the commanded broadcast start time. Therefore, as illustrated in FIG. 10, where the start time (=7:46 p.m.) of the program in the electronic program guide (EPG) included in the broadcast wave is slightly later than the start time (=7:45 p.m.) of the program in the program guide that can be presented to the user, the recorder 17 is programmed to reserve the program PO which is broadcast at the start time (=7:45 p.m.) of the program in the program guide that can be presented to the user. Thus, the program P0, which is different from the program P1 which the user wanted to program for recording reservation, is recorded by recording reservation, which is a problem.

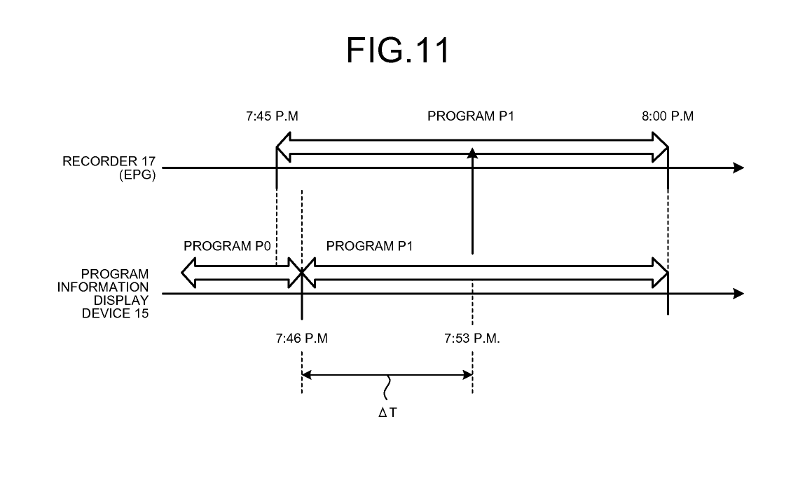

FIG. 11 is an explanatory diagram illustrating the third embodiment.

Therefore, in this third embodiment, in a case where recording reservation is performed with the program information display device 15, the start time of the program P1 in the program guide is not adopted as the designated time of the recording reservation. Instead, for example, a time at the middle of the start time and the end time of the program P1 (={start time+end time}/2) is adopted as the designated time of the recording reservation on the basis of the start time and the end time of the program P1 designated by the user in the program guide in question as illustrated in FIG. 11.

As a result, even if the start time (32 7:45 p.m.) of the program in the electronic program guide (EPG) included in the broadcast wave is slightly earlier than the start time (=7:46 p.m.) of the program in the program guide that can be presented to the user, the program P1 can be reliably recorded by recording reservation.

Likewise, even if the start time (=7:46 p.m.) of the program in the electronic program guide (EPG) included in the broadcast wave is slightly later than the start time (=7:45 p.m.) of the program in the program guide that can be presented to the user, the program P1 can be reliably recorded by recording reservation.

### Modification of Third Embodiment

In the above explanation, the time at the middle of the start time and the end time of the program P1 (={start time+end time}/2) is adopted as the designated time of the recording reservation. However, as long as it is known that deviation of the start time (or the end time) of each program is within a predetermined period of time, the embodiment can also be applied in the same manner when the time ΔT with respect to the start time of the program in the program guide that can be presented to the user in FIG. 11 is equal to or more than the maximum value of the predicted deviation.

As a result, even if the start time of the program in the electronic program guide (EPG) included in the broadcast wave is deviated from the start time (=7:46 p.m.) of the program in the program guide that can be presented to the user, the user can record the program by recording reservation without being aware of the deviation.

### Modification of Embodiments

A control program executed by the program information management device according to the present embodiment is provided as being recorded to a computer-readable recording medium such as a CD-ROM, a flexible disk (FD), CD-R, and a Digital Versatile Disk (DVD) as a file in an installable format or an executable format.

The control program executed by the program information management device according to the present embodiment may be provided in such a manner that the control program executed by the program information management device according to the present embodiment is stored to a computer connected to a network such as the Internet, so that the control program can be downloaded via the network. The control program executed by the program information management device according to the present embodiment may be configured to be provided or distributed via a network such as the Internet.

The control program executed by the program information management device according to the present embodiment may be configured to be provided upon being incorporated into a ROM and the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processing circuitry to make a request to a server to acquire a channel list via a communication network, to compare a first channel list acquired newly with a second channel list acquired previously, and, if the second channel list is to be updated with the first channel list, to acquire first program information corresponding to the first channel list from the server, and to generate a program guide by using the first channel list and the first program information.

2. The device of claim 1, further comprising:
a display to display various kinds of information; and
the processing circuitry to causes the display to display generated program guide.

3. The device of claim 1, wherein a timing at which the processing circuitry makes the request is a timing at which the device is activated, a timing when a certain period of time is elapsed since previous acquisition timing, or a timing at which a present time is a predetermined time.

4. The device of claim 1, further comprising:
a database that stores therein the first channel list and the first program information; and
the processing circuitry to generate the program guide based on the first channel list and the first program information stored in the database until a new channel list is acquired.

5. The device of claim 1, further comprising:
the processing circuitry to acquire, from the first program information, a broadcast start time and a broadcast end time of a program designated as a recording target among programs included in the program guide; and
the processing circuitry to perform recording reservation by assigning, with respect to an external recording device, a reservation time that is a time after the broadcast start time and before the broadcast end time.

6. The device of claim 5, further comprising the processing circuitry to set the reservation time by taking into account a predicted deviation in time between the broadcast start time and the broadcast end time based on the first program information and a broadcast start time and a broadcast end time when the first program information is transmitted with regard to a corresponding program in such a manner that the program is included in a broadcast wave.

7. The device of claim 5, further comprising the processing circuitry to set the reservation time as a time in the middle of a time zone between the broadcast start time and the broadcast end time.

8. A method executed by processing circuitry for managing program information, the method comprising:
making a request to a server so as to acquire a channel list via a communication network;
comparing a first channel list acquired this time with a second channel list acquired previously, and, if the second channel list is to be updated with the first channel list, acquiring first program information corresponding to the first channel list from the server; and
generating a program guide based on the first channel list and the first program information.

9. The method of claim 8, further comprising:
displaying, on a display, various kinds of information; and
causing the display to display generated program guide.

10. The method of claim 8, wherein a timing at which the making makes the request is a timing at which the processing circuitry is activated, a timing when a certain period of time is elapsed since previous acquisition timing, or a timing at which a present time is a predetermined time.

11. The method of claim 8, further comprising:
storing, in a database, the first channel list and the first program information; and
generating the program guide based on the first channel list and the first program information stored in the database until a new channel list is acquired.

12. A computer program product having a non-transitory computer readable medium including programmed instructions, wherein the instructions, when executed by a computer, cause the computer to perform:
making a request to a server so as to acquire a channel list via a communication network;
comparing a first channel list acquired this time with a second channel list acquired previously, and, if the second channel list is to be updated with the first channel list, acquiring first program information corresponding to the first channel list from the server; and
generating a program guide based on the first channel list and the first program information.

13. The computer program product of claim 12, wherein the instructions further cause the computer to perform:
displaying, on a display, various kinds of information; and
causing the display to display generated program guide.

14. The computer program product of claim 12, wherein a timing at which the making makes the request is a timing at which the processing circuitry is activated, a timing when a certain period of time is elapsed since previous acquisition timing, or a timing at which a present time is a predetermined time.

15. The computer program product of claim 12, wherein the instructions further cause the computer to perform:
storing, in a database, the first channel list and the first program information; and
generating the program guide based on the first channel list and the first program information stored in the database until a new channel list is acquired.
